(19) United States
(12) Patent Application Publication
(10) Pub. No.: US 2025/0246752 A1
(43) Pub. Date: Jul. 31, 2025

(54) THERMAL BARRIER ASSEMBLY FOR TRACTION BATTERY PACK

(71) Applicant: Ford Global Technologies, LLC, Dearborn, MI (US)

(72) Inventors: Di Zhu, Novi, MI (US); Shuya Shark Yamada, Novi, MI (US); Bhaskara Rao Boddakayala, Troy, MI (US); Joseph Polizzi, Chesterfield, MI (US); Gary J. Haddix, Monroe, MI (US); Thomas George Spehar, Dearborn Heights, MI (US)

(21) Appl. No.: 18/425,209

(22) Filed: Jan. 29, 2024

(51) Int. Cl. H01M 50/358; B60L 50/60; H01M 50/209; H01M 50/271

(52) U.S. Cl. CPC H01M 50/358; B60L 50/60; H01M 50/209; H01M 50/271; H01M 2220/20

(57) ABSTRACT

A thermal barrier assembly for a traction battery pack includes a frame extending longitudinally along an axis, and an expandable element secured to the frame. The expandable element is configured to expand against a structure in response to a battery cell venting event to block vent byproducts from flowing through a gap between the structure and the frame.

### TECHNICAL FIELD

This disclosure relates generally to thermal barrier assemblies having an expandable element that expands to shield areas of battery arrays from vent byproducts discharged from other battery arrays.

### BACKGROUND

A traction battery pack of an electrified vehicle can include groups of battery cells arranged in one or more cell stacks. Thermal barriers can be incorporated into the traction battery pack to help manage thermal energy.

### SUMMARY

In some aspects, the techniques described herein relate to a thermal barrier assembly for a traction battery pack, including: a frame extending longitudinally along an axis; and an expandable element secured to the frame, the expandable element configured to expand against a structure in response to a battery cell venting event to block vent byproducts from flowing through a gap between the structure and the frame.

In some aspects, the techniques described herein relate to a thermal barrier assembly, wherein the frame has an H-shaped axial cross-section.

In some aspects, the techniques described herein relate to a thermal barrier assembly, wherein the frame is a polymer-based material.

In some aspects, the techniques described herein relate to a thermal barrier assembly, wherein the expandable element is a foam.

In some aspects, the techniques described herein relate to a thermal barrier assembly, further including a mica shield sandwiched between the foam and the frame.

In some aspects, the techniques described herein relate to a thermal barrier assembly, wherein the structure is an enclosure wall.

In some aspects, the techniques described herein relate to a thermal barrier assembly, wherein the enclosure wall is an enclosure cover.

In some aspects, the techniques described herein relate to a thermal barrier assembly, wherein the expandable element configured to expand to redirect a flow of vent byproducts emitted from at least one battery cell within a first array from flowing over an array terminal of a second array, the frame and the expandable element disposed between the first array and the second array.

In some aspects, the techniques described herein relate to a thermal barrier assembly, wherein the expandable element is secured to a first side of the frame that faces the first array, a second side of the frame that faces the second array, and a third side of the frame that faces the structure.

In some aspects, the techniques described herein relate to a thermal barrier assembly, wherein the frame is secured to a cross-member that is between the first array and the second array.

In some aspects, the techniques described herein relate to a thermal barrier assembly, further including a biasing member and a sealing assembly, the biasing member configured to bias the sealing assembly against the structure.

In some aspects, the techniques described herein relate to a thermal barrier assembly, wherein the sealing assembly includes a sealing element held within a tray, the biasing member biasing the tray and the sealing element against the structure.

In some aspects, the techniques described herein relate to a thermal barrier assembly, wherein the biasing member, the tray, and the sealing element are each at least partially received within a channel of the frame.

In some aspects, the techniques described herein relate to a thermal barrier assembly, wherein the biasing member is a linear wave spring.

In some aspects, the techniques described herein relate to a method of shielding areas within a traction battery pack, including: in response to a venting event, expanding an expandable element against a structure within a traction battery pack to shield a battery array from vent byproducts discharged from at least one battery cell in another battery array.

In some aspects, the techniques described herein relate to a method, wherein the expandable element is secured to frame and the expandable element is expanded against the structure to block flow of the vent byproducts through a gap that is between the frame and the structure.

In some aspects, the techniques described herein relate to a method, further including biasing a sealing element away from the frame and against the structure,

In some aspects, the techniques described herein relate to a method, wherein the structure is a wall of an enclosure.

In some aspects, the techniques described herein relate to a method, wherein the expandable element is foam.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 2 according to an exemplary embodiment of the present disclosure.

FIG. 3 is a section view taken at line 3-3 in FIG. 2.

FIG. 4 illustrates a perspective view of a thermal barrier assembly from the battery pack of FIG. 2 according to the exemplary embodiment.

FIG. 5 illustrates an expanded view of the thermal barrier assembly in FIG. 4.

FIG. 6 illustrates the section view of FIG. 3 after an expandable element of the thermal barrier assembly has expanded.

FIG. 7 illustrates a section view through a thermal barrier assembly according to another exemplary embodiment.

### DETAILED DESCRIPTION

This disclosure details exemplary thermal barrier assemblies for use in traction battery packs. The thermal barriers systems include an expandable element that expands in response to a battery cell venting event to help shield areas from vent byproducts. Shielding areas, such as areas near array terminals, can help to manage thermal energy within the traction battery pack and prevent the venting event from cascading to other battery cells.

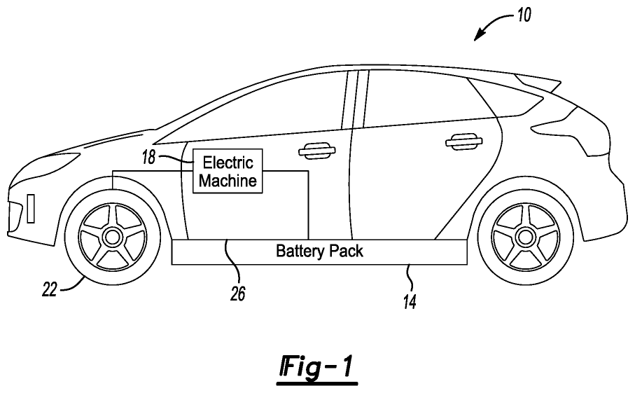

With reference to FIG. 1, an electrified vehicle 10 includes a battery pack 14, an electric machine 18, and wheels 22. The battery pack 14 powers an electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

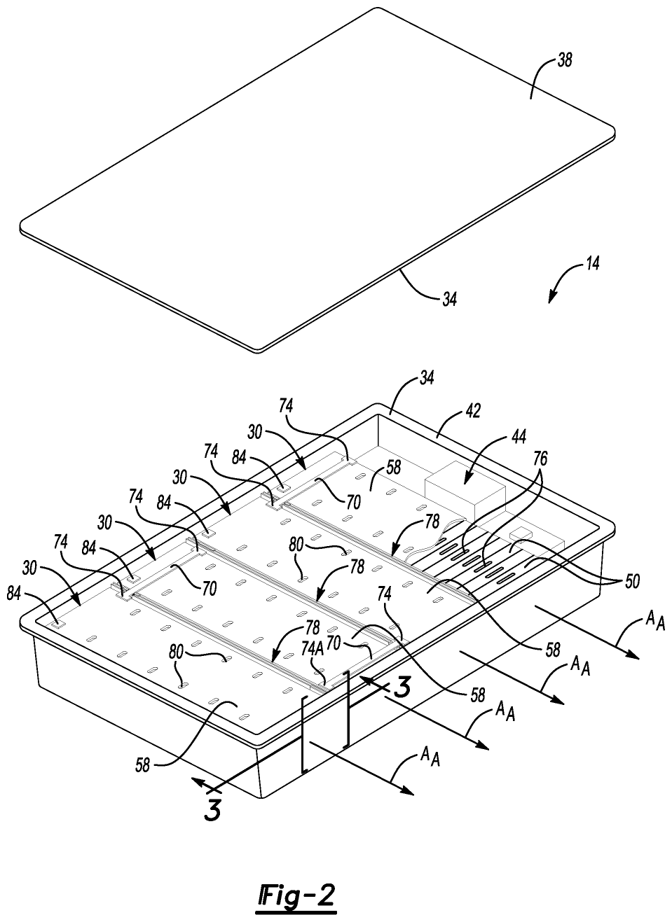

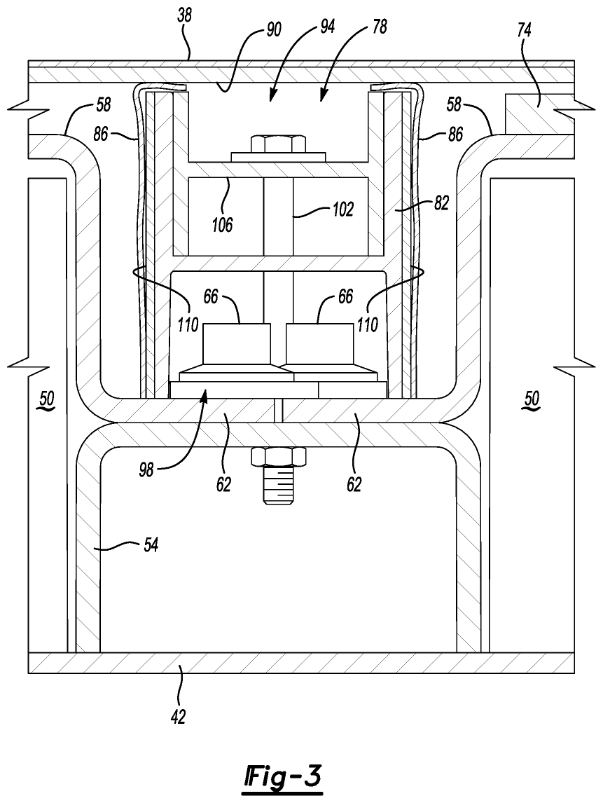

With reference now to FIGS. 2 and 3, the battery pack 14 includes a plurality of battery arrays 30 held within a battery pack enclosure 34. In the exemplary embodiment, the enclosure 34 includes an enclosure cover 38 and an enclosure tray 42. The enclosure cover 38 is secured to the enclosure tray 42 to provide an interior area 44 that houses the battery arrays 30. The enclosure cover 38 can be secured to the enclosure tray 42 using mechanical fasteners (not shown), for example.

Each of the battery arrays 30 includes a plurality of battery cells 50 (or simply, “cells”) stacked side-by-side relative to each other along a respective cell stack axis AA. The battery cells 50 store and supply electrical power. Although specific numbers of the battery arrays 30 and cells 50 are illustrated in the various figures of this disclosure, the battery pack 14 could include any number of the battery arrays 30 having any number of individual cells 50.

In an embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

The example battery pack 14 includes cross-member 54 disposed between arrays 30. The example cross-members 54 extend longitudinally in a direction that is parallel to the cell stack axes A_{A}. The cross-members 54 and the cell stack axes A_{A} extend in a cross-vehicle direction (i.e., from a driver side to a passenger side).

The battery arrays 30 each include an array cover 58. Side flanges 62 of the array cover 58 project outward over the cross-members 54. Mechanical fasteners 66 extend through the side flanges 62 to engage the cross-members 54 and help secure the battery arrays 30 within the interior area 44.

Busbars 70 electrically connect the arrays 30 together within the interior area 44. The busbars 70 connect to array terminals 74 of the battery arrays 30. The array terminals 74 extend into the arrays 30 and can provide passageways into and out of the battery arrays 30.

From time to time, pressure and thermal energy within one or more of the battery cells 50 in the battery pack 14 can increase. This can lead to the battery cells 50 expelling vent byproducts, which can include gas and debris.

The vent byproducts can be expelled from the associated battery cell 50 through a designated vent 76 within the housing, such as a membrane that yields in response to increased pressure, or through a ruptured area of the associated battery cell 50. The battery pack 14 experiences a venting event when one or more of the battery cells 50 are venting by expelling vent byproducts. From the vents 76 in the battery cells 50, the vent byproducts can move through vents 80 in the respective array cover 58.

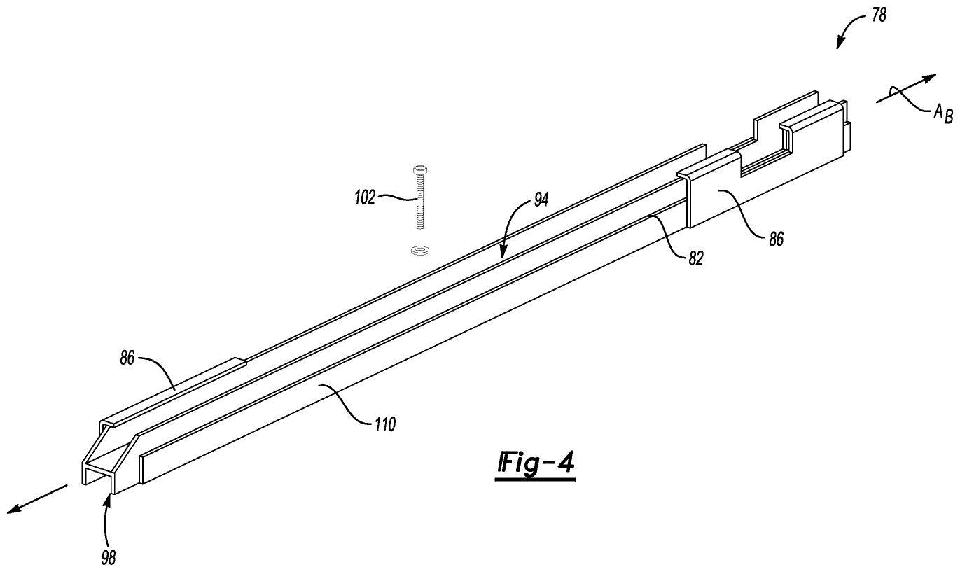

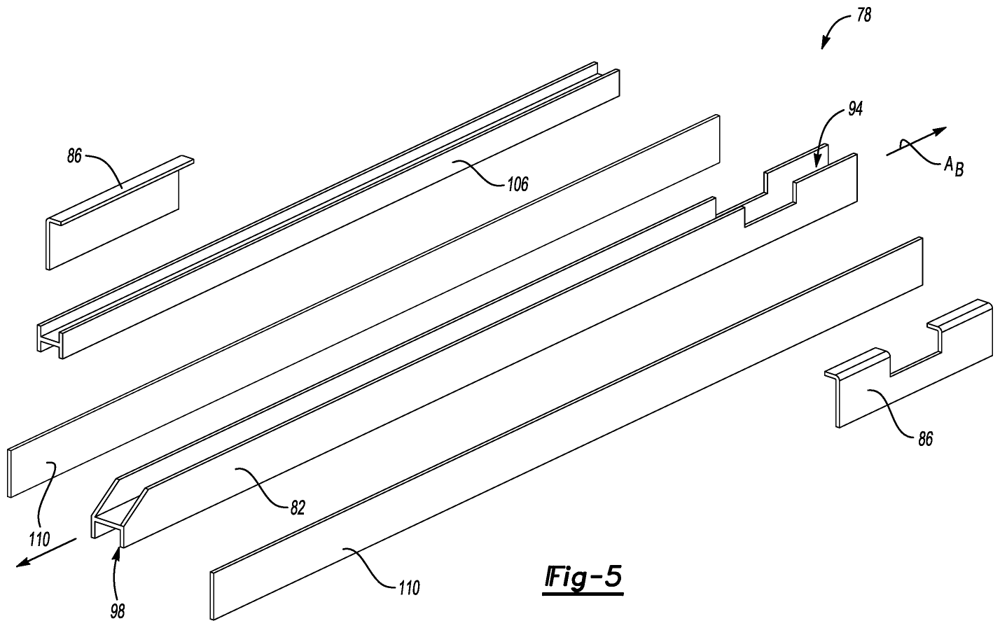

With reference now to FIGS. 4-6 and continuing reference to FIGS. 1 and 2, mounted atop the cross-members 54 are thermal barrier assemblies 78. Each of the thermal barrier assemblies 78 includes, in this example, a frame 82 extending longitudinally along a barrier axis A_{B} and an expandable element 86 secured to the frame 82.

In this example, the expandable element 86 does not extended over an entire longitudinal length of the frame 82, but over the portion or portions that are near to one of the array terminals 74. The expandable elements 86 can extend over notches in the frames 82.

The expandable element 86 can be a foam, for example, such as a ceramic or silicone foam with an intumescent additive. The expandable element 86 can expand when exposed to sufficient thermal energy, such as thermal energy associated with the venting event. In some examples, the expandable element 86 is activated to expand at temperatures that range from 160 to 200 degrees Celsius. The expandable element 86 can, in some examples, expand 1.5 to 4 times its original size.

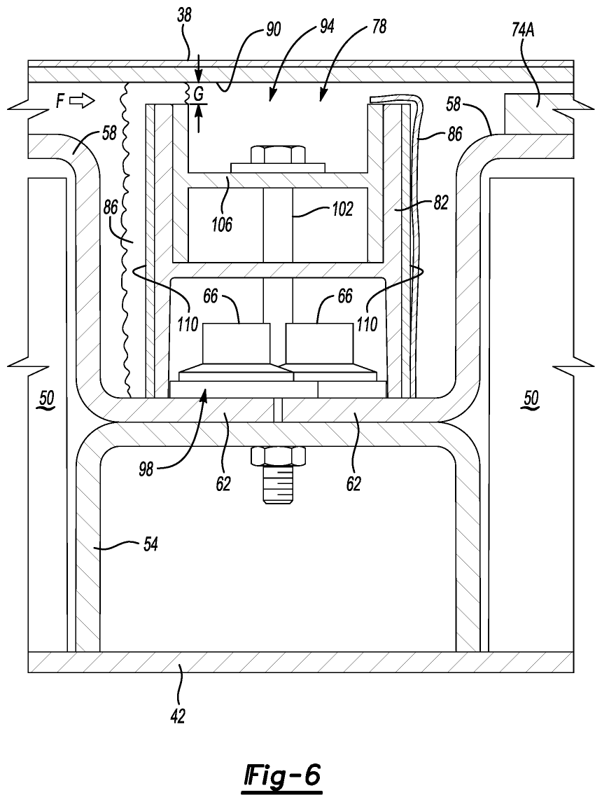

FIG. 6 shows the expandable element 86 after being expanded by a flow F of vent byproducts emitted from battery cells 50 within one of the arrays 30 during a venting event. The expandable element 86 expands against a structure. This can shield the array terminal 74A from the flow F of vent byproducts discharged from at least one battery cell 50 of an adjacent battery array 30. The expandable element 86 can shield other areas as well, such as low-voltage connectors 84 of the battery arrays 30.

In this example, the structure that the expandable element 86 expands against is a wall of the enclosure 34 and, in particular, an underside 90 of the enclosure cover 38, which, in this example, is lined with a sheet of mica.

The expanding of the expandable element 86 can fill a gap G that is between the enclosure cover 38 and the frame 82 to block the flow F of vent byproducts from moving through the gap G to the terminal 74A. The flow F is redirected axially away from the terminal 74A and the passageways into the array 30 that are associated with the terminal 74A of the neighboring array. Directing the flow F away from these passageways can help to prevent the vent byproducts from entering the passageways and raising thermal energy levels of the neighboring array 30, which can reduce the likelihood of the venting event cascading to one or more battery cells 50 of the neighboring array 30. Rather than move directly to a position adjacent the array terminal 74 of the neighboring array 30, the flow F of vent byproducts can be rerouted axially, which dissipates thermal energy. The vent byproducts are eventually expelled from the battery pack 14 through an enclosure vent, for example.

In this example, the flow F can cause the cover 38 to lift and move upwards away from the array 30 and the frame 82 increasing a size of the gap G from prior to the venting event. Using the expandable element 86 ensures that the gap G, which is increased in size, is blocked.

The frame 82 of the thermal barrier assembly 78 has a H-shaped cross-sectional profile with a channel 94 that opens upward and a channel 98 that opens downward. Upward and downward are, for purposes of this disclosure, with reference to ground and an orientation of the battery pack 14 when installed with the vehicle 10.

The frame 82 can be a polymer-based material. The frame 82 is an extruded structure in some examples.

In this example, one or more mechanical fasteners 102 extend through apertures in the frame 82 to engage the respective cross-members 54 and secure the thermal barrier assembly 78.

A bracing structure 106 is disposed within the channel 94 in this example. The bracing structure 106 enhances the structural integrity of the thermal barrier assembly 78. The bracing structure 106, however, is not required.

Sections of the expandable element 86 are disposed on selected areas on the horizontally facing sides of the frame 82. The sections of the expandable element 86 and are wrapped over the top side of the frame 82. The example embodiment includes sections of the expandable element 86 on opposing sides of the frame 82. In other examples, a section of the expandable element 86 is only disposed on one side of the frame 82. Adhesive, for example, could be used to secure the expandable element.

In the example embodiment, sections of a mica shield 110 are sandwiched between the section of the expandable element 86 and the frame 82 on the horizontally facing sides of the frame 82. The mica shield 110 can help to provide a barrier to the flow F of vent byproducts moving toward the array terminal, and especially a barrier to particulates within the flow F of vent byproducts. In this example, the mica shield 110 does not wrap over the top of the frame 82 as particulates within the flow F are unlikely to contact the top of the frame 82. In other examples, the mica shield 110 could wrap over the frame 82.

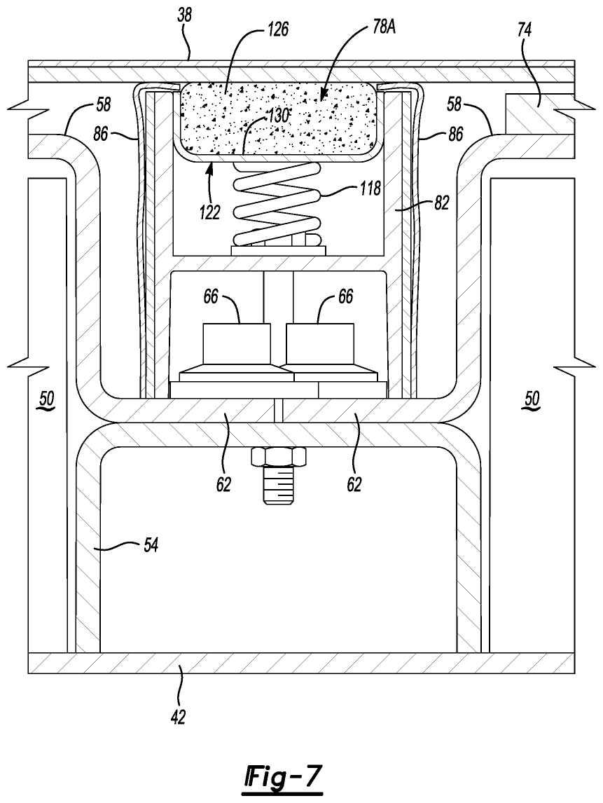

With reference now to FIG. 7, in another example embodiment, a thermal barrier assembly 78A includes a biasing member 118 and a biased seal assembly 122 that are at least partially received within the channel 94 of the frame 82. The biased seal assembly 122 includes a sealant 126 held within a tray 130. The sealant 126 can be a foam that expands in response to thermal energy. The biasing member 118 can press the sealant 126 of the biased seal assembly 122 against the wall of the enclosure 34 to help ensure that any gap is blocked during a venting event.

The biasing member 118 is a coil spring in this example. In another example, the biasing member 118 could be a linear wave spring or a metal-based container having a spring or biasing function.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A thermal barrier assembly for a traction battery pack, comprising:
a frame extending longitudinally along an axis; and
an expandable element secured to the frame, the expandable element configured to expand against a structure in response to a battery cell venting event to block vent byproducts from flowing through a gap between the structure and the frame.

2. The thermal barrier assembly of claim 1, wherein the frame has an H-shaped axial cross-section.

3. The thermal barrier assembly of claim 1, wherein the frame is a polymer-based material.

4. The thermal barrier assembly of claim 1, wherein the expandable element is a foam.

5. The thermal barrier assembly of claim 4, further comprising a mica shield sandwiched between the foam and the frame.

6. The thermal barrier assembly of claim 1, wherein the structure is an enclosure wall.

7. The thermal barrier assembly of claim 6, wherein the enclosure wall is an enclosure cover.

8. The thermal barrier assembly of claim 1, wherein the expandable element configured to expand to redirect a flow of vent byproducts emitted from at least one battery cell within a first array from flowing over an array terminal of a second array, the frame and the expandable element disposed between the first array and the second array.

9. The thermal barrier assembly of claim 8, wherein the expandable element is secured to a first side of the frame that faces the first array, a second side of the frame that faces the second array, and a third side of the frame that faces the structure.

10. The thermal barrier assembly of claim 8, wherein the frame is secured to a cross-member that is between the first array and the second array.

11. The thermal barrier assembly of claim 1, further comprising a biasing member and a sealing assembly, the biasing member configured to bias the sealing assembly against the structure.

12. The thermal barrier assembly of claim 11, wherein the sealing assembly includes a sealing element held within a tray, the biasing member biasing the tray and the sealing element against the structure.

13. The thermal barrier assembly of claim 12, wherein the biasing member, the tray, and the sealing element are each at least partially received within a channel of the frame.

14. The thermal barrier assembly of claim 13, wherein the biasing member is a linear wave spring.

15. A method of shielding areas within a traction battery pack, comprising:
in response to a venting event, expanding an expandable element against a structure within a traction battery pack to shield a battery array from vent byproducts discharged from at least one battery cell in another battery array.

16. The method of claim 15, wherein the expandable element is secured to frame and the expandable element is expanded against the structure to block flow of the vent byproducts through a gap that is between the frame and the structure.

17. The method of claim 16, further comprising biasing a sealing element away from the frame and against the structure.

18. The method of claim 15, wherein the structure is a wall of an enclosure.

19. The method of claim 15, wherein the expandable element is foam.
